(19) United States
(12) Patent Application Publication
(10) Pub. No.: US 2026/0285734 A1
(43) Pub. Date: Sep. 24, 2026

(54) ELECTRODE SUPPORT FOR GLASS-MAKING FURNACE

(71) Applicant: SAINT-GOBAIN ISOVER, COURBEVOIE (FR)

(72) Inventors: Romain SANTAMARIA, COURBEVOIE (FR); Michel LISMONDE, COURBEVOIE (FR)

(21) Appl. No.: 19/474,392

(22) PCT Filed: Apr. 11, 2024
(86) PCT No.: PCT/EP2024/059849

§ 371 Date: Oct. 10, 2025

(30) Foreign Application Priority Data
Apr. 12, 2023 (FR) FR2303634

(51) Int. Cl. C03B 5/03

(52) U.S. Cl. CPC C03B 5/03

(57) ABSTRACT

A support for a melting electrode submerged from the surface of a molten bath, the support having a power supply system and a first cooling device including an inner pipe and an outer pipe which are associated with one another for the circulation of a cooling liquid, the outer pipe of the first cooling device being surrounded by an electrical insulator, the electrical insulator being surrounded by a second cooling device including an inner pipe and an outer pipe which are associated with one another for the circulation of a cooling liquid. At least the outer pipe of the second cooling device has a substantially parallelepipedal, or parallelepipedal, cross-section.

### PRIOR ART

The invention relates to a device for melting a vitrifiable material, in particular for use in the production of flat glass, hollow glass or insulating fibers, hereinafter referred to as a glass-making furnace.

Such a furnace consists of a tank that is surmounted by a superstructure. The tank is the area wherein the raw material is melted. The superstructure is a structure placed on the tank to form an enclosed area. This superstructure thus comprises a side wall and a crown closing the furnace from above.

This furnace comprises heating means to bring the raw material to a melting temperature. These heating means take the form, for example, of electrodes through which energy is dissipated by Joule effect into the melt from so-called immersion electrodes.

These heating means comprise an electrode attached to a support which comprises the power supply system and an electrode cooling device. The cooling device consists of two pipes associated with one another for the circulation of a coolant. This is a network of pipes adapted for the circulation of a cooling fluid (known as a “water jacket”). The outer pipe of this cooling device is surrounded by a jacket of insulating material. This jacket is, in turn, surrounded by a second device of the water jacket type with two concentric pipes associated with one another for the circulation of a cooling liquid.

In this known system, the pipes of the two cooling devices of the water jacket type are circular.

This configuration makes it possible to create electrode arms for small or medium-sized furnaces, i.e. for arms no longer than 2 m.

However, current trends point to the need for large furnaces that can deliver substantial glass production. However, these large furnaces require special heating systems. In the case of Joule heating with electrodes, it is therefore necessary to have longer arms than the existing ones. This greater length results in mechanical stresses on said arms.

### SUMMARY OF THE INVENTION

The purpose of the present invention is to provide a glass-making furnace which provides a configuration of arms allowing an increase in their length for use in a large furnace.

For this purpose, the invention relates to a support for a melting electrode submerged from the surface of a molten bath, said support having a current supply system, a first cooling device comprising an inner pipe and an outer pipe which are associated with one another for the circulation of a cooling liquid, the outer pipe of said first cooling device being surrounded by an electrical insulator, said electrical insulator being surrounded by a second cooling device comprising an inner pipe and an outer pipe which are associated with one another for the circulation of a cooling liquid, characterized in that at least the outer pipe of the second cooling device has a substantially parallelepipedal, or parallelepipedal, cross-section.

According to one example, the inner pipe of the second cooling device is substantially parallelepipedal, or parallelepipedal, in cross-section.

According to one example, the outer pipe of the first cooling device is substantially parallelepipedal, or parallelepipedal, in cross-section.

According to one example, the inner pipe of the first cooling device is substantially parallelepipedal, or parallelepipedal, in cross-section.

According to one example, the parallelepiped cross-section is square.

According to one example, non-parallelepiped pipes are circular or substantially circular in cross-section.

In one example, the outer pipe of the first cooling device is conductive and forms the current supply system.

According to one example, the support has a horizontal span of more than 2000 mm, preferably more than 2500 mm, more preferably more than 3000 mm, more preferably more than 3500 mm, more preferably more than 3700 mm, more preferably more than 3900 mm.

### DESCRIPTION OF THE FIGURES

Other particular features and advantages will become clear from the following description thereof, given by way of indication and in an entirely non-limiting manner, with reference to the appended drawings, wherein:

FIG. 1 shows a view of a furnace;

FIG. 2 shows a cross-section of an electrode support;

FIGS. 3, 5, 6 and 7 schematically show cross-sectional views of variants of a support according to the invention;

FIG. 4 shows a cross-section of an electrode support with the difference in area between a square cross-section and a circular cross-section.

### DETAILED DESCRIPTION OF THE INVENTION

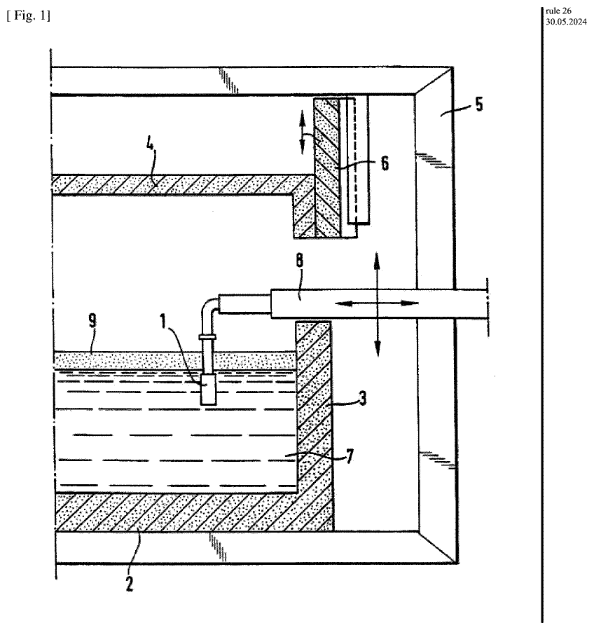

The diagram in FIG. 1 shows part of a melting furnace with immersion electrodes 1. The furnace consists of a refractory basin with a floor 2 and side walls 3. Above the basin, the refractory roof 4 is suspended from a metal frame 5, shown in part, said metal frame 5 straddles the furnace. Movable refractory walls 6 are provided which, when in the lowered position, i.e. resting on the side walls 3, partially isolate the molten bath 7 from the surrounding atmosphere.

Only openings in the walls 6 are provided for the passage of electrode holders 8.

This low position of the walls 6 is adopted when the furnace is in standby mode and no longer needs to be supplied with raw materials. This avoids excessive heat loss, and the risk of damaging all surrounding equipment.

The electrode 1 is submerged in the surface of the molten bath 7 beneath the layer 9 of raw materials to be melted. This layer 9, which covers the molten bath 7 during normal operation, thermally insulates the basin and prevents heat loss.

The electrode 1 is attached to the support 8, which includes the power supply system and a cooling device 20 for the electrode 1, which are not shown in this FIG. 1. The electrode 1 is supplied with single-phase, three-phase or two-phase current.

The support 8 is itself connected to a mechanism (not shown) which enables an electrode 1 to be removed from the bath, for example, for replacement or repair.

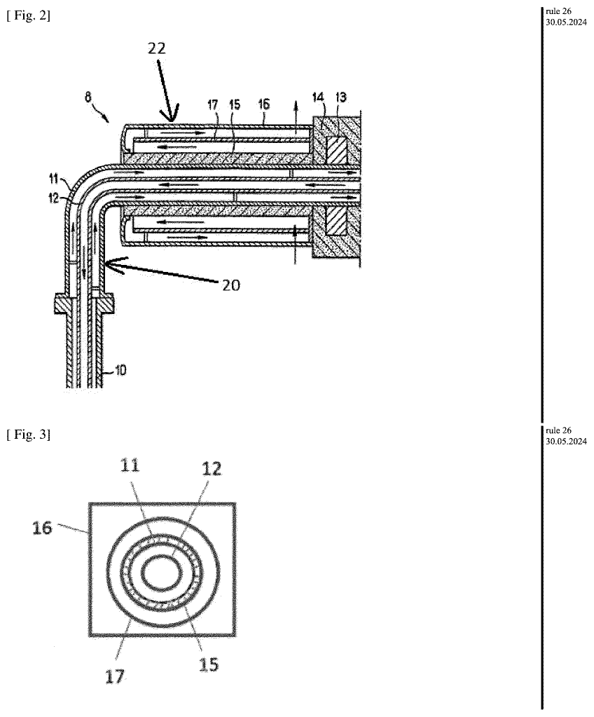

In FIG. 2, electrode 1, for example made of molybdenum, is attached via a current-conducting element 10 to the pipe 11, which forms part of the current-conducting cooling device. The element 10 is an extension which is screwed onto the pipe 11. The electrode 1 is attached to the other end of this extension 10. This design makes it easy to dismantle the extension 10/electrode 1 assembly, as the screw-in area is never submerged in the molten bath. Indeed, if the pipe 11 were longer and dipped directly into the bath, it would be possible to attach the electrode 1 directly to it, for example by screwing. On the other hand, it would be much more difficult to remove the electrode, as the attachment point would have soaked into the molten bath.

In our assembly, the change is very easy, but still requires replacing the extension 10 at the same time as electrode 1. This extension 10 can be surrounded, at least partially, by a refractory material thick enough to prevent direct contact with the raw materials or the molten bath.

The extension 10 also allows coolant to pass through to the electrode to cool it down.

Screw-in attachment is attractive because it allows rapid replacement. Electrode replacement can be a frequent occurrence, not only because of wear and tear, but also because the electrodes can be modified, particularly in terms of length, so as to alter the level of immersion and thus the energy input to the furnace. The pipe 11 can be made of metal for good rigidity and conductivity. This metal can be steel or any other possible alloy or metal.

Within this first pipe 11 is a second pipe 12, for example concentric with the outer wall of the pipe 11. This second pipe 12, for example, is attached at various points to the inner surface of the first pipe 11.

The combination of these two pipes 11 and 12 allows water to circulate and thus constitutes a first water-jacket type cooling device between the inner wall of 11 and the outer wall of 12. As the cooling system is designed to cool the electrode 1, the second pipe 12 passes through the extension 10. It is thus understood that the first cooling device 20 comprises an inner pipe 12 and an outer pipe 11.

At the other end of the first pipe 11, a supply collar 13, made of copper for example, is attached to an insulating casing 14. This collar 13 enables the first pipe 11 to be brought to the desired voltage, and the latter, being an electrical conductor, to supply the electrode 1 at this same voltage.

Around the first pipe 11 is placed an electrically insulating material 15, advantageously made of a refractory material of the type marketed under the reference MURATHERM 500 M. The material 15 is in the form of one or more sleeves which surround and rest on part of the external surface of the first pipe 11. This electrically insulating material makes the electrode support accessible without any risk of electrocution for operators approaching the molten bath. The material 15 is itself surrounded by a concentric envelope 16 wherein a cooling liquid such as water circulates. This “water-jacket”-type envelope 16 includes an internal sleeve 17 which allows the circulation of a cooling liquid forming a second cooling device 22. It is thus understood that the second cooling device 22 comprises an inner pipe 17 and an outer pipe 16.

This second cooling device, which also comprises two pipes, prevents the insulating material from overheating, even if it is chosen to withstand fairly high temperatures and has already been partially cooled by the first cooling device.

On the other hand, the outer surface of the electrode support 8 remains relatively cool and can be handled or at least approached by an operator even when the furnace is idle and the support 8 is heated essentially by radiation from the molten bath, where the raw material layer 9 is absent.

The various elements 11, 12, 15, 16, 17 constitute hollow pipes. It is understood that elements 11 and 16 are outer pipes and elements 12 and 17 are inner pipes.

According to the invention, the pipes of the first cooling device 20 of the water jacket type and the pipes of the second cooling device 22 of the water jacket type have specific shapes and cross-sections. It is understood that the shapes quoted may have one or more occasional variations.

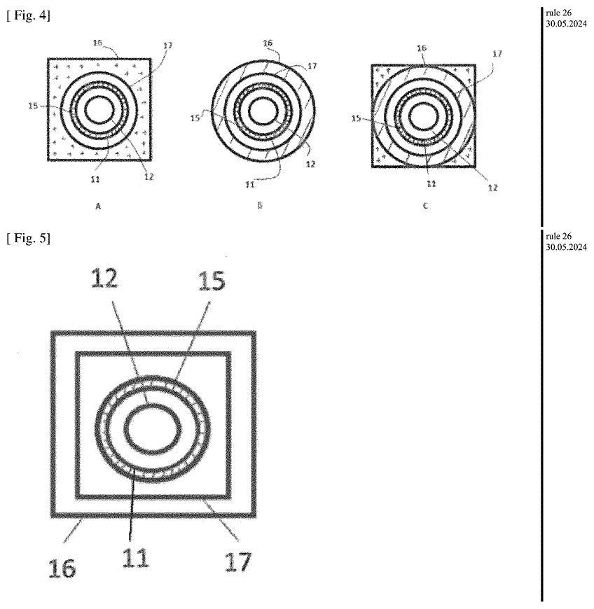

In one embodiment, the two pipes 11, 12 of the first cooling device are circular or substantially circular. In this first embodiment, the pipes of the second cooling device are such that the envelope 17 is circular or substantially circular, while the sleeve 16 is substantially parallelepipedal or parallelepipedal in shape, as can be seen in FIG. 3. Preferably, this parallelepiped shape is a square.

This difference in shape between the two pipes 16, 17 of the second cooling device provides mechanical advantages for the production of large arms. This is because the space between two pipes 16, 17 is a space wherein a coolant circulates. As it circulates, this coolant contributes its mass to the entire heating system of the electrode type. However, for an arm of a certain size, this mass leads to mechanical stress. The aim is to achieve a balance between cooling performance and overall weight.

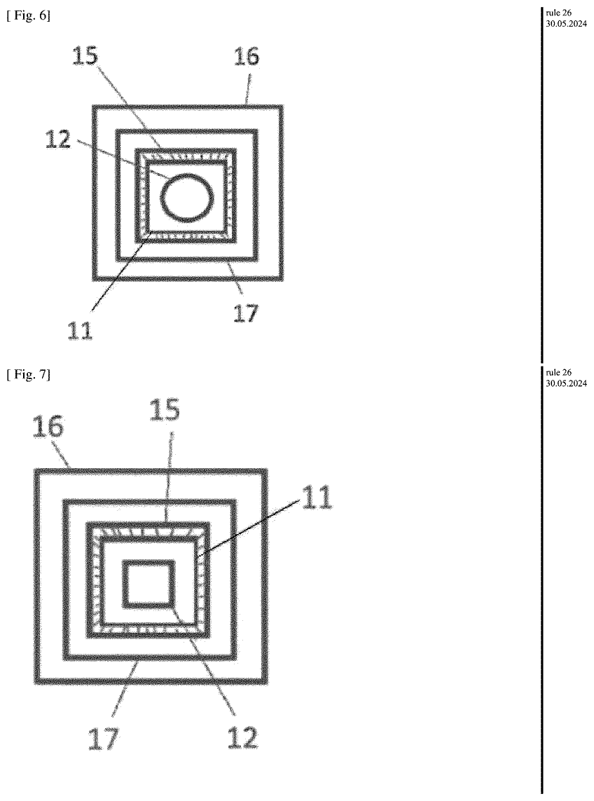

The difference in shape between the two pipes results in a space which, for the same overall dimensions, has a larger surface area, as shown in FIG. 4. This larger surface area enhances cooling by improving coolant circulation.

As can be seen in FIG. 4, examples of configurations can be seen with, in a first case visible in A, a parallelepiped-shaped outer pipe 16 and, in a second case visible in B, a circular outer pipe 16. Example C shows the difference in surface area between examples A and B. We can see that for the same overall dimensions, i.e. for the same distance between the central axis and the surface of the outer pipe 16, example A provides a larger cooling cross-sectional area. In fact, a 10 cm square gives a surface area of 100 cm2 . For a 10 cm diameter circle, a surface area of 78.5 cm2 is obtained. This larger surface area allows more coolant to pass through. On the other hand, it is possible to reduce the size of the pipes for the same amount of coolant. This reduction in the size of the pipes reduces the weight of the support 8 and therefore improves its mechanical strength.

In a variant as shown in FIG. 5, the envelope 16 of the second cooling device is also substantially parallelepipedal, or parallelepipedal, in shape, preferably square. Thus, the two pipes of the second cooling device are parallelepipedic, preferably square.

In another variant, the envelope 16 and/or sleeve 17 have a rectangular shape.

In a variant shown in FIG. 6, the pipe 11 also has a parallelepiped shape, preferably square. This implies that the envelope 16 and the sleeve 17 have a substantially parallelepiped or parallelepiped shape, preferably square. This variant does not preclude the use of circular pipes 16 and 17, but the overall dimensions and weight would be greater.

In a variant shown in FIG. 7, the pipe 12 also has a parallelepiped shape or a parallelepiped one, preferably square. This implies that the pipe 11, envelope 16 and sleeve 17 have a parallelepiped shape, preferably square. The square shape of all the pipes means a larger surface area for the same footprint. So, compared with a circular shape, pipes 11, 12, 16, 17 of the invention provide better cooling. At the same time, however, this means a smaller footprint for the same coolant flow.

The various coolant inlet and outlet lines are not shown in the figures.

The coolant used for cooling is advantageously demineralized water, which means that the same circuits can be used for both cooling systems without any risk of current conduction to the external cooling system, which is also grounded.

The electrode and its support described in this way enable it to be used without risk in normal operating mode, since no accessible device is powered on, and without risk of damage to the support when the furnace is put on standby.

The device comprising the electrode and its support, as described in the invention, therefore retains the various advantages associated with electric melting using an electrode submerged in the surface of the molten bath, as listed above. These include good thermal yields, good quality of molten material despite changes in drawing, longer furnace life due to less damage to the refractories, and easy electrode replacement.

In addition, the device according to the invention makes it possible to avoid the presence of fully submerged electrodes for standby periods, or the full-time presence of a protection system preventing the presence of operators in the vicinity of continuously energized elements.

Alternatively, the pipe 11 is not an electrical conductor. Electrical conduction is provided by a dedicated conduit or rod. In the case of a conduit, this can be arranged to be surrounded by the pipe 11. In this way, the insulating material 15 surrounds and is in contact with the conductive conduit. In this case, the pipe 11 is, for example, a steel casing, while the conduit dedicated to electrical conduction is made of a conductive material such as copper.

In the case of conduction by a rod, the rod is ideally placed in the pipe 12. This arrangement forces the pipe 12, and therefore the pipe 11, envelope 16 and sleeve 17, to have a larger diameter to compensate for the presence of this rod. The material used for the rod is a conductive copper-type material.

According to the invention, the support 8 is akin to an arm with a horizontal projection. This projection has a horizontal span of more than 2000 mm, preferably more than 2500 mm, more preferably more than 3000 mm, more preferably more than 3500 mm, more preferably more than 3700 mm, more preferably more than 3900 mm.

Of course, the present invention is not limited to the shown example but is susceptible to various variants and modifications which will become apparent to the person skilled in the art.

1. A support for a melting electrode submerged from a surface of a molten bath, the support having a power supply system and a first cooling device comprising an inner pipe and an outer pipe which are associated with one another for circulation of a cooling liquid, the outer pipe of the first cooling device being surrounded by an electrical insulator, the electrical insulator being surrounded by a second cooling device comprising an inner pipe and an outer pipe which are associated with one another for the circulation of a cooling liquid, wherein at least the outer pipe of the second cooling device has a substantially parallelepipedal, or parallelepipedal, cross-section.

2. The support according to claim 1, wherein the inner pipe of the second cooling device is substantially parallelepipedal, or parallelepipedal, in cross-section.

3. The support according to claim 1, wherein the outer pipe of the first cooling device is substantially parallelepipedal, or parallelepipedal, in cross-section.

4. The support according to claim 1, wherein the inner pipe of the first cooling device is substantially parallelepipedal, or parallelepipedal, in cross-section.

5. The support according to claim 1, wherein the parallelepiped cross-section is square.

6. The support according to claim 1, wherein the pipes with a non-parallelepiped cross-section are circular or substantially circular in cross-section.

7. The support according to claim 1, wherein the outer pipe of the first cooling device is conductive and forms the current supply system.

8. The support according to claim 1, having a horizontal span of more than 2000 mm.

9. The support according to claim 8, wherein the horizontal span is more than 2500 mm.

10. The support according to claim 9, wherein the horizontal span is more than 3000 mm.

11. The support according to claim 10, wherein the horizontal span is more than 3500 mm.

12. The support according to claim 11, wherein the horizontal span is more than 3700 mm.

13. The support according to claim 12, wherein the horizontal span is more than 3900 mm.
